(19) United States
(12) Patent Application Publication
(10) Pub. No.: US 2013/0239942 A1
(43) Pub. Date: Sep. 19, 2013

(54) SUPPORT AND HANDLING APPARATUS OF SLAB AND METHOD FOR FEEDING SLABS TO A MACHINE FOR MACHINING THE SAME

(71) Applicant: Luigi Guazzoni, Verbania (IT)

(72) Inventor: Luigi Guazzoni, Verbania (IT)

(73) Assignee: GMM S.P.A., Gravellona Toce (VB) (IT)

(21) Appl. No.: 13/825,160

(22) PCT Filed: Sep. 19, 2011
(86) PCT No.: PCT/IB2011/002169

§ 371 Date: Jun. 5, 2013

(30) Foreign Application Priority Data
Sep. 20, 2010 (IT) MI2010A001707

(51) Int. Cl. B28D 7/04

(52) U.S. Cl. CPC B28D 7/04
USPC 125/35

(57) ABSTRACT

A support apparatus of slab materials includes a support structure, defining a horizontal work plane of a slab; a plurality of first supporting and sliding rollers of the slab on a first horizontal lying plane and a plurality of second supporting and sliding rollers of the slab on a second horizontal lying plane beneath the first lying plane. The first supporting and sliding rollers and the second supporting and sliding rollers are movable along a vertical direction with respect to the support structure, to bring the first and second lying plane beneath the, or at the, work plane and to load or withdraw a slab onto/from the work plane.

### TECHNICAL FIELD OF THE INVENTION

The present invention relates to a support and handling apparatus of slab materials, in particular, but not exclusively, stone materials, like, for example, marble and granite, and to a method for feeding such slab materials to the work plane of a machine for machining the same.

### RELATED ART

Machines for machining slab materials, and in particular stone materials, essentially comprise a table that defines a work plane on which the slab to be machined is placed, a tool-holder group to which a machining tool is associated, for example a circular blade or a milling cutter, an apparatus for moving the tool-holder group over the work plane and a drive and control unit equipped with a suitable operator interface. A machine of this type is for example described in Italian patent application MI2010A000876, in the name of the Applicant.

In the following of the present description and in the subsequent claims, the term “machining” is used to generically indicate any operation carried out on a piece of material, like for example cutting, squaring or shaping.

Conventionally, different apparatuses for supporting and moving the slabs are used to feed the relative machining machines. Such apparatuses pick up the slabs to be machined from a storage station and feed them to the work plane of the machine.

For example, amongst the most common supporting and moving apparatuses there are bridge cranes and lift trucks, often equipped with suction cups for picking up the slabs. An example of a lift truck with suction cups is described in German patent DE 4332991. In general, these apparatuses have proven bulky and complicated to use.

Alternatively, supporting and moving apparatuses have been proposed comprising a conveyor belt. The conveyor belt is equipped with a portion extending directly under the tool-holder group of the machining machine, therefore being configured as a work plane of the machine. These systems suffer from a major drawback: the tool of the machining machine, for example a circular blade, cannot sink beyond a certain limit into the slab being machined so as not to damage the belt of the conveyor belt.

As an alternative to the supporting and moving apparatuses described above, machining machines have been proposed having a work plane provided with motorised rollers for the movement of the slabs. The motorised rollers allow both the feeding of the pieces to be machined into the action area of the tool of the machine, and the unloading of the machined pieces. The motorised rollers, are both rotatable to transmit the movement to the slabs and vertically movable between a first raised work position, at which the slab rests directly on the rollers, and a second lowered rest position, at which the rollers do not interact with the slab, which rests on fixed support elements of the work plane. The rollers take the lowered position when the tool of the machine must machine the slab, in this case without running the risk of damaging the rollers. The rollers take the raised position when the slab must be fed to the machine or unloaded therefrom after having been machined.

Disadvantageously, the motorised rollers are subject to frequent jamming and breaking caused by the debris and by the dusts produced during the machining of the slabs, with obvious repercussions on productivity.

In general, the systems described above for supporting and moving slabs share a major drawback, linked to the speed of the feeding and unloading operations. The described systems, in fact, do not to maximise the productivity of the slab-machining machine since, for each slab machined, the machine remains inactive during the feeding and unloading operations of the slab itself. In other words, the machine is subject to a more or less prolonged standstill condition during the operations of feeding a new slab or of unloading a machined slab.

Until now, therefore, the solutions used to support and feed slab materials have proven to be the bottleneck of the production cycle. However, for some time now there has been a need to maximise the productivity of machines for machining the described materials.

European patent application EP 1 749 624 A1 describes an apparatus for positioning and unloading slabs comprising a pair of trucks suitable for supporting a respective slab to be machined and horizontally movable in an alternate manner between a position for working the slab and a loading/unloading position of the slab to be machined/already machined.

German patent application DE 100 40 552 A1 describes an apparatus for loading and unloading a machine for machining slab material comprising a storage station formed by a plurality of vertically stacked compartments, each of which is suitable for housing a respective slab, and a transportation device equipped with a support frame movable along vertical guides to move a single slab from the storage station to the machine for machining and vice-versa.

### SUMMARY OF THE INVENTION

The Applicant has developed an alternative to the previous solutions which avoids prolonged machine standstills that up to now have been necessary to complete the feeding and unloading operations of the slab materials.

The technical problem underlying the present invention is therefore that of providing a support and handling apparatus of slab materials which allows to solve in a simple and effective manner the drawbacks of conventional solutions, allowing at the same time to maximise productivity.

In a first aspect thereof, the invention therefore relates to a support and handling apparatus of slab materials according to claim 1.

More specifically, the invention relates to a support and handling apparatus of slab materials, comprising:

a) a support structure, defining a horizontal work plane of a slab material;

b) a plurality of first supporting and sliding rollers defining a first horizontal lying plane of said slab material;

c) a plurality of second supporting and sliding rollers defining a second horizontal lying plane of said slab material beneath the first lying plane;

wherein said first and second supporting and sliding rollers are rotatably supported by respective support frames;
the apparatus further comprising:

d) a driving device of the support frames with respect to the support structure to vertically translate said support frames between:

d1) a first operative position wherein:
the second lying plane defined by the second supporting and sliding rollers is substantially coincident with a loading/unloading plane of the slab material positioned above the work plane to receive slab material to be machined;
the first lying plane defined by the first supporting and sliding rollers is substantially coincident with a waiting/unloading plane of a machined slab material, positioned above the loading/unloading plane;

d2) a second operative position wherein:
the second lying plane defined by the second supporting and sliding rollers is substantially coincident with the work plane;
the first lying plane defined by the first supporting and sliding rollers is substantially coincident with said loading/unloading plane of the slab material to unload the machined slab material; and

d3) a third non-operative position wherein:
said first and second supporting and sliding rollers are positioned beneath the work plane so as not to engage slab material to be machined supported by the support structure at the work plane.

Advantageously, the apparatus according to the present invention makes it possible to feed a new slab to be machined to the work plane of a machine and at the same time to unload a machined slab from the same work plane, so that the standstill of the machine due to the exchange of slabs is reduced to a minimum.

This outstanding advantage is achieved, as will become clearer hereafter, in the following way: a first slab to be machined is arranged on the second supporting and sliding rollers, and then is positioned on the second lying plane; the second rollers are lowered to lay the slab to be machined on the work plane, which preferably coincides with the work plane of the machine to be fed.

When the machining of the slab has ended, the relative unloading from the work plane occurs in the following way: the first supporting and sliding rollers engage with the lower surface of the slab and lift the same up to a predetermined distance from the work plane, at the waiting/unloading plane positioned above the loading/unloading plane of the slab material. At this time, a new slab to be machined, supported by the second supporting and sliding rollers on the second lying plane substantially coinciding with the loading/unloading plane of the slab material, is inserted between the machined slab and the work plane.

Thereafter, the first and second rollers are simultaneously lowered to leave the new slab to be machined on the work plane and to take the previously machined slab to the loading/unloading plane from which the slab is unloaded by sliding on the first supporting and sliding rollers.

The described procedure is cyclically repeated for all of the slabs to be fed to the machine for machining the slab material.

In other words, the machined slabs and the slabs to be machined are continuously alternated above the work plane so as to minimise the time normally required to feed the slabs to the machines by means of known apparatuses, with clear advantages in terms of productivity.

The apparatus according to the present invention also makes it possible to minimise the risks of breaking or damaging the slabs. The slabs moved by the apparatus do not undergo to impacts or bending which may cause chips or cracks.

Preferably, both the first supporting and sliding rollers and the second supporting and sliding rollers are rotatably supported by the respective support frames on opposite sides with respect to the support structure.

Preferably, the rollers are idly mounted on the respective frames. In an alternative embodiment, some rollers can be motorised.

More preferably, the first supporting and sliding rollers and the second supporting and sliding rollers comprise respective series of rollers opposite with respect to the support structure of the apparatus.

In this way, the slabs are advantageously supported by the first or by the second supporting and sliding rollers only at the lower surface and at opposite edges of the slabs, so that the latter are suspended over the work plane.

Preferably, the first supporting and sliding rollers comprise pairs of opposite rollers facing each other on opposite sides of the support structure and spaced apart from each other at a distance slightly greater than the width of the work plane. The second supporting and sliding rollers have an analogous configuration.

Even more preferably, the rollers of the first supporting and sliding rollers and of the second supporting and sliding rollers are arranged in pairs and the corresponding rollers of each pair are arranged on opposite sides with respect to the support structure of the apparatus so as to define the aforementioned support configuration in a simple and effective manner.

The aforementioned series of opposite rollers thus define a respective first and second lying plane spaced apart at a predetermined distance along the vertical direction; in particular, in the apparatus of the invention the first rollers constitute upper supporting and sliding rollers and the second rollers constitute lower supporting and sliding rollers, defining in this way a configuration with superimposed and spaced apart support and lying planes.

Preferably, all of the supporting and sliding rollers are translationally supported by the support structure by means of the aforementioned support frames which are preferably associated to at least one respective upright of the support structure.

Preferably, each frame is connected to a respective upright by means of a screw coupling of the driving device. For example, each frame is hinged to a bracket connected to the upright by means of the screw coupling of the driving device.

Preferably, the apparatus comprises a second driving device of the support frames, adapted to move the support frames with respect to the support structure along a transversal direction with respect to the vertical direction between a first position, wherein the opposite rollers of the first and second supporting and sliding rollers are proximal to one another, and a second position wherein the opposite rollers of the first and second supporting and sliding rollers are distal to one another.

In this way, the first and second rollers are movable with respect to the support structure along a transversal direction with respect to the vertical direction and are advantageously moved along the transversal direction with respect to the work plane to completely disengage the slab positioned with precision on the work plane so as to allow its machining.

Preferably, the movement of the support frames along the transversal direction is obtained by horizontally moving the frames or by hinging the frames to the support structure and by rotating them in opposite directions with respect to the support structure.

In a first preferred embodiment, each support frame is horizontally movable with respect to a respective upright of the support structure.

In a first preferred alternative embodiment, each support frame is angularly movable with respect to a respective upright of the support structure in the opposite direction with respect to the other frame.

The opposite rollers of the first and second supporting and sliding rollers are thus preferably movable along the transversal direction by means of translation or rotation with respect to the support structure.

In both cases, the rollers of a series of rollers are moved in the opposite direction with respect to the rollers of the opposite series of rollers.

In a particularly preferred embodiment, each frame is movable with respect to the respective upright along a vertical direction and is angularly movable with respect to the same upright along an opposite direction with respect to the frame of the opposite rollers.

Preferably, the vertical and transversal movements of the opposite rollers of the first and second supporting and sliding rollers are synchronised with each other. In other words, the rollers arranged on opposite sides with respect to the support structure move in synchrony both in the vertical movements and in the transversal movements.

Preferably, the driving device that vertically moves each support frame with respect to the support structure also comprises one or more motors that control the movements of each frame with respect to the relative upright.

Preferably, the waiting/unloading plane coincides with a second unloading plane of the machined slab material.

In a second aspect thereof, the present invention relates to a method for feeding a slab material to a work plane of a machine for machining the slab material by means of a support and handling apparatus of said slab material according to claim 11.

More specifically, the method according to the present invention comprises the steps of:
a) feeding a first slab material to be machined on a loading/unloading plane defined by said apparatus above a horizontal work plane of the machining machine, at a predetermined distance from said work plane;
b) lowering the first slab material by means of the apparatus to lay it on the work plane for machining the slab material;
c) engaging the first machined slab material and lifting it to a waiting plane defined in said apparatus above the loading/unloading plane of the first machined slab material;
d) feeding a second slab material to be machined on the loading/unloading plane defined between the work plane and the waiting plane of the first machined slab material;
e) lowering the second slab material to be machined to lay it on the work plane and the first machined slab material to position it at the loading/unloading plane;
f) horizontally unloading the first machined slab material from the loading/unloading plane, and
g) repeating steps c)-f) on the second slab material and on subsequent slab materials.

Preferably, steps a)-g) are carried out by means of the apparatus described above. In particular:
step a) is preferably carried out by pushing the first slab material on a second horizontal lying plane defined by the second supporting and sliding rollers;
step b) is preferably carried out by moving the second supporting and sliding rollers downwards so that the second lying plane is substantially coincident with the work plane of the machine;
step c) is preferably carried out by supporting the first machined slab material by means of said first supporting and sliding rollers on a first horizontal lying plane defined by said first rollers;
step d) is preferably carried out by pushing a second slab material to be machined on the second horizontal lying plane defined by the second supporting and sliding rollers;
step e) is preferably carried out by moving the first and second supporting and sliding rollers so that the second horizontal lying plane is substantially coincident with the work plane of the machine and the first lying plane is substantially coincident with the loading/unloading plane; and
step f) is preferably carried out by pushing the first machined slab material away from the loading/unloading plane.

In a third aspect thereof, the present invention relates to an alternative method for feeding a slab material to a work plane of a machine for machining the slab material by means of a support and handling apparatus of said slab material according to claim 13.

More specifically, the method according to the present invention comprises the steps of
a) feeding a first slab material to be machined on a loading plane defined by said apparatus above a horizontal work plane of said machine, at a predetermined distance from said work plane;
b) lowering the first slab material by means of the apparatus to lay it on the work plane for machining the slab material;
c) engaging the first machined slab material and lifting it to an unloading plane defined in said apparatus above the loading plane of the machined slab material;
d) picking up the first machined slab material from the unloading plane;
e) feeding a second slab material to be machined on the loading plane defined between the work plane and the unloading plane of the first machined slab material;
f) lowering the second slab material to be machined to lay it on the work plane; and
g) repeating steps c)-f) on the second slab material and on subsequent slab materials.

Preferably, in this preferred embodiment of the method of the invention the unloading plane of the first machined slab material coincides with the waiting plane of the previous embodiment.

Preferably, steps a)-g) are carried out by means of the apparatus described above. In particular:
step a) is preferably carried out by pushing the first slab material on a second horizontal lying plane defined by the second supporting and sliding rollers,
step b) is preferably carried out by moving the second supporting and sliding rollers downwards so that the second horizontal lying plane is substantially coincident with the work plane of the machine,
step c) is carried out by supporting the first machined slab material by means of the first supporting and sliding rollers on a first horizontal lying plane defined by the first rollers;
step e) is carried out by pushing a second slab material to be machined on the second horizontal lying plane defined by the second supporting and sliding rollers; and
step f) is carried out by moving the second supporting and sliding rollers downwards so that the second horizontal lying plane is substantially coincident with the work plane of the machine.

Advantageously, the method according to the present invention in its various embodiments makes it possible to minimise the time needed to feed the work plane of a machine with the new slabs to be machined, with minimum risks in terms of possible breaking of the slabs.

Preferably, the method also comprises, in both of the aforementioned embodiments, a step b1), intermediate to steps b) and c), wherein the first and second rollers are further lowered so as to position them beneath the work plane.

Preferably, the method also comprises, in both of the aforementioned embodiments, the step h), intermediate to steps b) and c), wherein the second supporting and sliding rollers are transversally moved at a distal position with respect to the work plane to disengage the first slab material to be machined and the first supporting and sliding rollers are transversally moved at a proximal position with respect to the work plane to engage the first machined slab material.

### BRIEF DESCRIPTION OF THE DRAWINGS

Additional features and advantages of the present invention will become more clearly apparent from the following description of a preferred embodiment thereof, made hereafter, for indicating and not limiting purposes, with reference to the attached drawings. In the drawings:

FIG. 1 is a perspective view of a support apparatus according to the present invention and of an outer element associated to the same;

FIGS. 1A and 1B are schematic views, side and front respectively, of the apparatus shown in FIG. 1, in a first configuration;

FIGS. 2A and 2B are schematic views, side and front respectively, of the apparatus shown in FIG. 1, in a second configuration;

FIGS. 3A and 3B are schematic views, side and front respectively, of the apparatus shown in FIG. 1, in a second configuration;

FIGS. 4A and 4B are schematic views, side and front respectively, of the apparatus shown in FIG. 1, in a third configuration;

FIGS. 5A and 5B are schematic views, side and front respectively, of the apparatus shown in FIG. 1, in a fourth configuration;

FIGS. 6A and 6B are schematic views, side and front respectively, of the apparatus shown in FIG. 1, in a fifth configuration;

FIGS. 7A and 7B are schematic views, side and front respectively, of the apparatus shown in FIG. 1, in a sixth configuration;

FIGS. 8A and 8B are schematic views, side and front respectively, of the apparatus shown in FIG. 1, in a seventh configuration;

FIGS. 9A and 9B are schematic views, side and front respectively, of the apparatus shown in FIG. 1, in an eighth configuration;

FIGS. 10A and 10B are schematic views, side and front respectively, of the apparatus shown in FIG. 1, in a ninth configuration;

FIGS. 11A and 11B are schematic views, side and front respectively, of the apparatus shown in FIG. 1, in a tenth configuration;

FIGS. 12A and 12B are schematic views, side and front respectively, of the apparatus shown in FIG. 1, in an eleventh configuration;

FIG. 13 is a perspective view of the apparatus shown in FIG. 1, in the seventh configuration;

FIG. 14 is a perspective view of the apparatus shown in FIG. 1, in the fourth configuration;

FIG. 15 is a perspective view, from below, of the apparatus shown in FIG. 1, in the fourth configuration.

### DETAILED DESCRIPTION OF A PREFERRED EMBODIMENT OF THE INVENTION

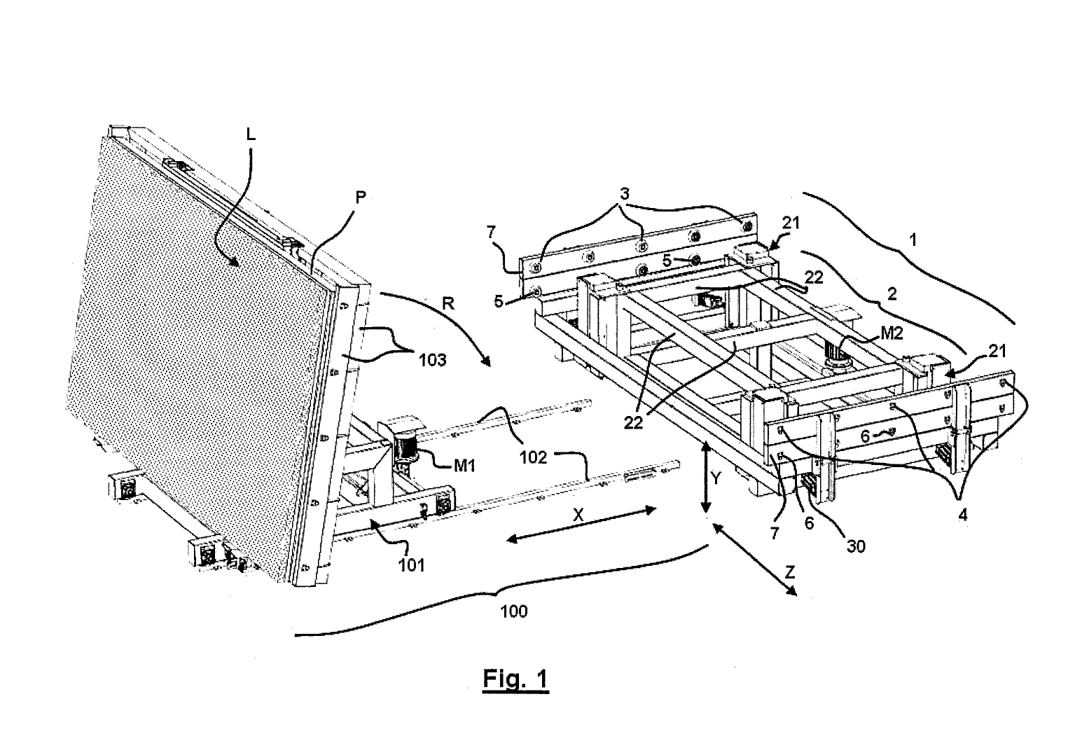

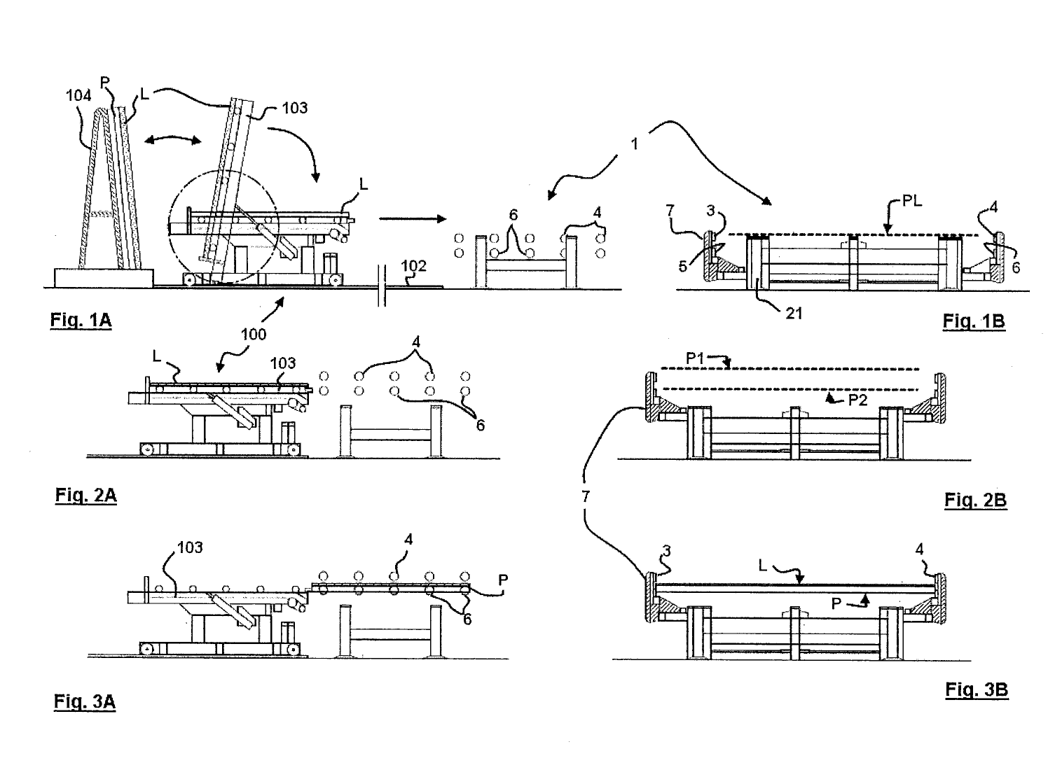

In FIG. 1, a support and handling apparatus according to a preferred embodiment of the present invention for supporting and feeding material in slabs L to the work plane PL of a machine for machining the same slabs L, not illustrated in the figures, is generally indicated at 1.

A loading truck associated to the supporting apparatus 1 is generally indicated at 100.

Reference letter P indicates a slab-carrying platform, i.e. a framework in which a slab L is housed. The slab-carrying platform P can have a wooden lower base in direct contact with the lower surface of the slab L.

The loading truck 100, which is not part of the present invention, essentially comprises a frame 101, movable on two tracks 102 fixed to the floor, and a support element 103 for slab-carrying platforms P connected to the frame 101 in a tillable manner by means of an articulation for example controlled by a hydraulic system. The support element 103 is tillable between the almost vertical position shown in FIG. 1 and a completely horizontal position. The tracks 102 extend in a first direction X transversal with respect to the apparatus 1 according to the present invention between a shelving on which the slabs L to be machined are stored and the apparatus 1 according to the present invention. Therefore, the truck 100, which is motorised, moves a slab L to be machined from the shelving (not shown) and after having horizontally positioned the slab takes the latter close to the apparatus 1 to then be able to transfer the slab onto the apparatus. The movement of the slabs L from the shelving to the slab-carrying platform P of the truck 100 is operated by a technician with known systems.

In FIG. 1 a slab-carrying platform P, containing a slab L, has already been positioned on the support element 103 of the truck 100 in slightly inclined position to avoid accidental overturning of the platform P. The platform P is ready to be tilted into horizontal position by rotating the support element 103 of the truck 100 along the direction indicated by the arrow R. When the platform P is horizontal, the truck 100 is moved by the motor M1 close to the apparatus 1.

The truck 100 is provided with a motorised pushing/extracting element (not shown), which pushes the platform P with the relative slab L out of the horizontal support element 103, to feed the apparatus 1, and picks up the platform P with the machined slab L from the same apparatus 1 to reposition them on the support element 103.

The apparatus 1 comprises a support structure 2, which defines the horizontal work plane PL of the machine for machining the slab L, i.e. the platform P containing the slab L. In the embodiment shown in the attached figures, the support structure 2 is constituted by vertical uprights 21 coupled with one another by means of cross members 22; the work plane is defined by the upper surface of the uprights 21. In other words, the slab-carrying platform P or the slab L itself can be laid on the uprights 21, in a perfectly horizontal position.

The apparatus 1 also comprises a plurality of first upper rollers 3 and 4 for the support and sliding of the platform P with the slab L on a first horizontal lying plane P1. Preferably, the first supporting and sliding rollers 3 and 4 are arranged in a left row and in a right row with respect to a direction X transversal to the apparatus 1, so as to be on opposite sides with respect to the support structure 2. For example, the two rows comprise an equal number of corresponding and opposite rollers 3 and 4.

The apparatus 1 also comprises a plurality of second lower rollers 5 and 6 for the support and sliding of the platform P with the slab L on a second horizontal lying plane P2 beneath the first lying plane P1. Preferably, the second supporting and sliding rollers 5 and 6 are also arranged in a left row and in a right row with respect to the direction X, so as to be on opposite sides with respect to the support structure 2. For example, the two rows comprise an equal number of corresponding and opposite rollers 5 and 6.

Preferably and in order to have the lying planes P1, P2 arranged one below the other, the rollers 5 are arranged below the rollers 3 and the rollers 6 are arranged below the rollers 4.

Preferably, the rollers 3-6 are idly mounted on suitable support frames 7, preferably shared between the rows of rollers on a same side as shown in FIG. 1.

The support frames 7 and the rollers 3-6 idly mounted thereon are movable along a vertical direction Y and along a direction Z transversal to the vertical direction Y and to the direction X with respect to the support structure 2.

Alternatively, in another embodiment not shown in the drawings, the rollers 3 are mounted on a first frame, the rollers 4 are mounted on a second frame, the rollers 5 are mounted on a third frame and the rollers 6 are mounted on a fourth frame and said frames have driving devices independent from each other.

Preferably, the frames 7 are alternatively movable along a direction Y parallel to the uprights 21 and are angularly movable with respect to the latter along a direction away from the structure 2, as indicated by the arrows R1 and R2 in FIGS. 14 and 15.

To this end, the apparatus 1 comprises a first driving device of the frames 7 with respect to the support structure 2 to vertically translate the support frames 7.

Preferably, the first driving device of the frames 7 includes a motor M2 and a screw coupling 31 (see FIGS. 13 and 15); in this way, each frame 7 is preferably connected to a respective upright 21 by means of the screw coupling 31 of the first driving device.

In order to tilt the frames 7 with respect to the uprights 21 along the direction away from the structure 2 as illustrated by the arrows R1, R2 in FIGS. 5B, 14 and 15, the apparatus 1 comprises a second driving device comprising hydraulic driving devices 30 (visible in FIGS. 13 and 15).

A method for feeding slabs to a work plane of a machine for machining the slab material according to a preferred embodiment of the invention will now be described with reference to the schematic FIGS. 1A-12B, in which for the sake of simplicity some constructive details have been omitted (such as for example the frames 7 in some figures).

Moreover, this preferred embodiment of the method of the invention will be illustrated from a start-up transient condition, in which the apparatus 1 neither supports nor moves any slab material L.

FIGS. 1A and 1B show the apparatus 1 at the same point in time and in the same first configuration, waiting to receive a slab L from the truck 100. A technician picks up the platform P and the corresponding slab L from the store 104 and places it on the support element 103, which is then tilted, as schematically shown in FIG. 1A, to bring the platform P and the slab L to a horizontal position. The frames 7 that support the rollers 3-6 are in a lowered position, as shown in FIG. 1B. Reference PL indicates the horizontal work plane defined by the upper portions of the uprights 21 of the support structure 2. In practice, the work plane PL is the same work plane of the machine used for machining the slab L.

The truck 100 moves on the tracks 102 and approaches the apparatus 1, as shown in FIG. 2A. The frames 7 are moved to a completely raised position with respect to the support structure 2, as indicated in FIG. 2B, so that the apparatus takes a second configuration. The upper rollers 3 and 4 define a first horizontal lying plane P1 of the slab L and the lower rollers 5 and 6 define a second horizontal lying plane P2 of the slab L, beneath the first plane P1. In this second configuration, both the lying planes P1 and P2 of the slab L are positioned above the work plane PL.

FIGS. 3A and 3B show—with the apparatus 1 still in the second configuration—a first step of the method of the invention, during which a first slab material L to be machined is fed onto a loading/unloading plane defined by the apparatus 1 above the work plane PL of the machine, at a predetermined distance from the work plane PL.

During this first step of the method, the slab-carrying platform P is preferably transferred by means of a pushing/extracting element (not shown) from the truck 100 to the support apparatus 1 on the rollers 5 and 6 and at the second lying plane P2. In this configuration, the apparatus 1 is configured like a roller table.

As clearly shown in FIG. 3B, the slab-carrying platform P is positioned above the work plane PL defined by the top of the uprights 21 and at a certain distance therefrom, so as to define a space between the platform P and the work plane PL.

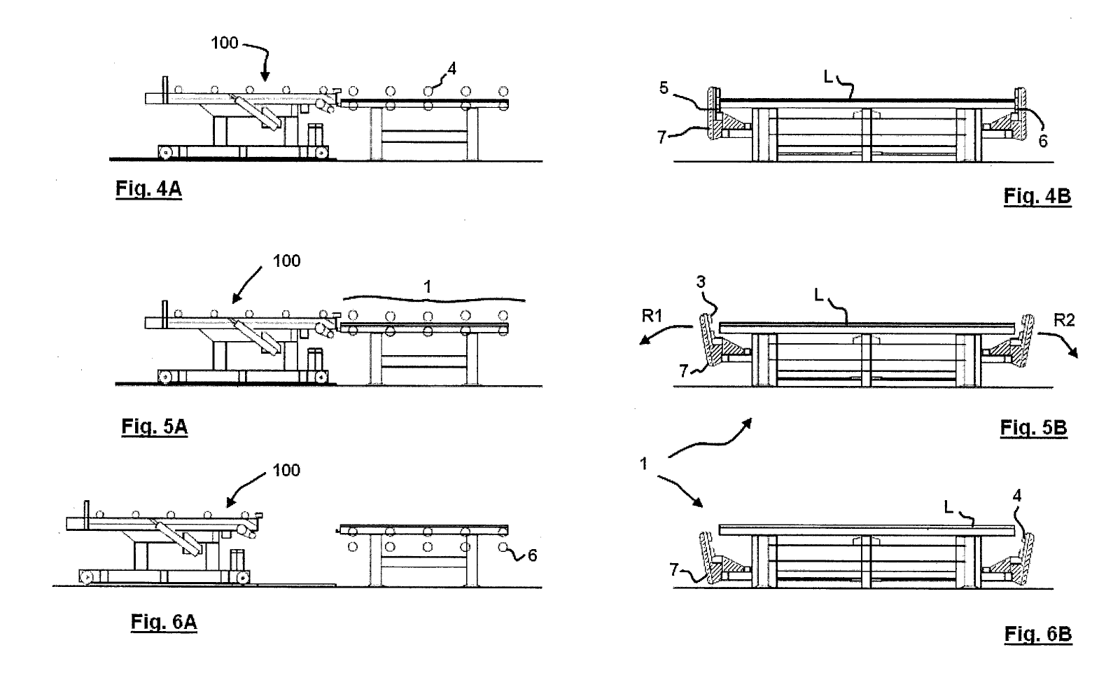

FIGS. 4A and 4B show a second step of the method, subsequent to the preceding one, wherein the first slab material L to be machined is lowered by means of the apparatus 1 to lay it on the work plane PL for machining the slab material.

During this second step of the method, the apparatus 1 is in a third configuration, subsequent to the preceding one, wherein the support frames 7 are preferably lowered with respect to the support structure 2 down to a height at least sufficient to stably position the slab-carrying platform P on the work plane PL. In this configuration, the work plane PL and the second lying plane P2 are substantially coincident with each other (apart from minor differences due to adjustments). The slab-carrying platform P is no longer vertically supported by the lower rollers 5 and 6, but directly by the uprights 21. The translating movement of the frames 7 with respect to the respective uprights 21 is preferably achieved by means of the first driving device comprising the screw coupling 31 (partially visible in FIGS. 13 and 14) and the motor M2.

FIGS. 5A and 5B show a preferred step of the method, wherein the first slab material L to be machined is preferably disengaged from the second lower supporting and sliding rollers 5, 6 to facilitate its machining.

During this preferred step, the apparatus 1 takes a fourth configuration, subsequent to the preceding one, wherein the support frames 7, with the respective rollers 3, 4; 5, 6 are moved away from the support structure 2, for example rotated by means of the second driving device comprising the hydraulic driving devices 30 along the directions indicated by the arrows R1 and R2, i.e. along opposite directions with respect to the support structure 2, to disengage the platform P and the slab L which remain completely supported by the uprights 21.

FIGS. 6A and 6B show a further preferred step of the method of the invention, wherein the apparatus 1 takes a fifth configuration, subsequent to the preceding configuration, in which the support frames 7 are preferably further lowered by means of the first driving device to the corresponding minimum height. The truck 100 is moved away and returns to its initial position to pick up a new slab L2 to be machined.

In such a preferred configuration, the first upper supporting and sliding rollers 3, 4 and the second lower supporting and sliding rollers 5, 6 are all positioned below the work plane PL.

When the apparatus 1 is in its fifth configuration, the slab L completely disengaged from the rollers is machined by a tool of a machine the work plane of which is the plane PL described above. For example, the slab L can be cut, milled, bevelled, etc.

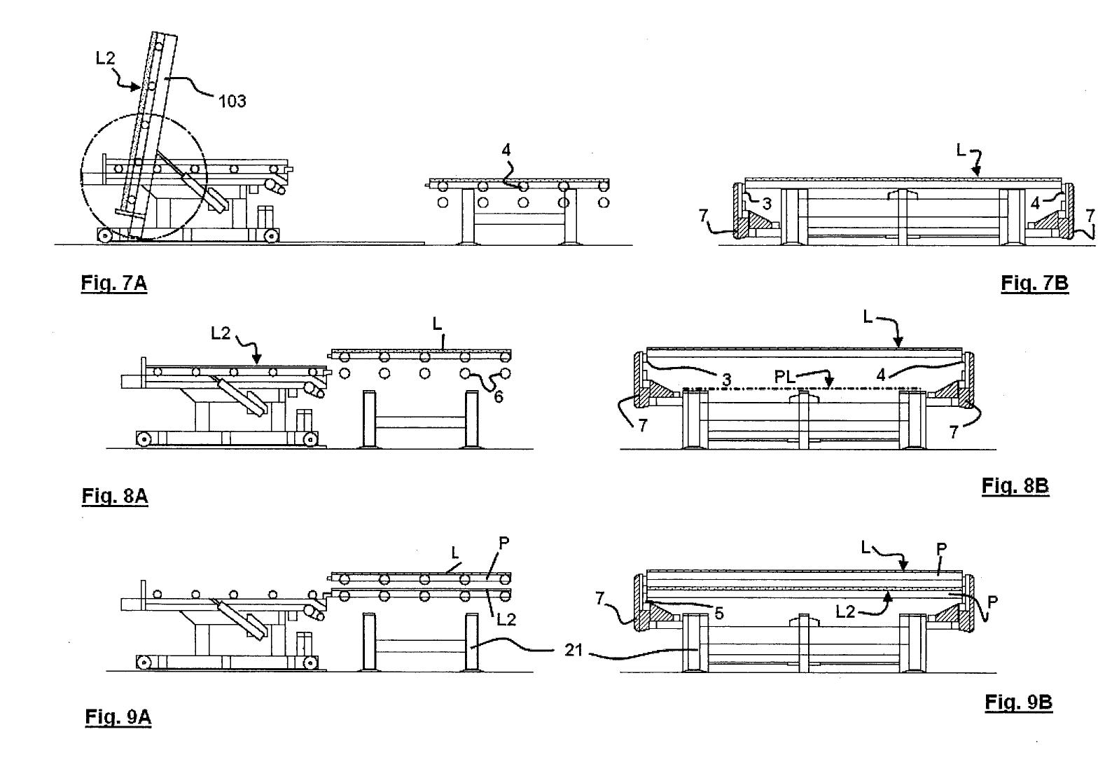

At the end of the machining operations of the first slab L, the method includes a step wherein the apparatus 1 takes a sixth configuration shown in FIGS. 7A and 7B; 8A and 8B, in which the first machined slab L is engaged (FIGS. 7A and 7B) and lifted (FIGS. 8A and 8B) above the work plane PL up to a waiting plane defined in the apparatus 1 above the loading/unloading plane.

During this step of the method, the support frames 7 of the apparatus 1 are preferably rotated in the initial vertical position parallel to the uprights 21 by means of the second driving device and are partially lifted by means of the first driving device with respect to the minimum height shown in FIG. 6B just enough to take the rollers into engagement with the platform P. There is a difference with respect to the third configuration: the rollers abutting against the lower surface of the platform P are now the upper rollers 3 and 4 and no longer the lower rollers 5 and 6.

FIGS. 8A and 8B show a seventh configuration of the apparatus 1, subsequent to the preceding configuration, wherein the frames 7 are further lifted with respect to the support structure 2; the platform P is lifted above the work plane PL at a certain distance therefrom. Meanwhile, the truck 100 approached the apparatus 1 with the new slab L2 to be machined.

FIGS. 9A and 913 show a subsequent step of the method of the invention, wherein a second slab material L2 to be machined is fed onto the loading/unloading plane defined between the work plane PL and the waiting plane of the first machined slab L.

During this fourth step of the method, the apparatus 1 takes an eighth configuration, subsequent to the preceding configuration, in which the second slab L2 is preferably loaded onto the second lower rollers 5 and 6, i.e. arranged between the work plane PL, from which it is in any case raised, and the first machined slab L supported by the first upper rollers 3 and 4.

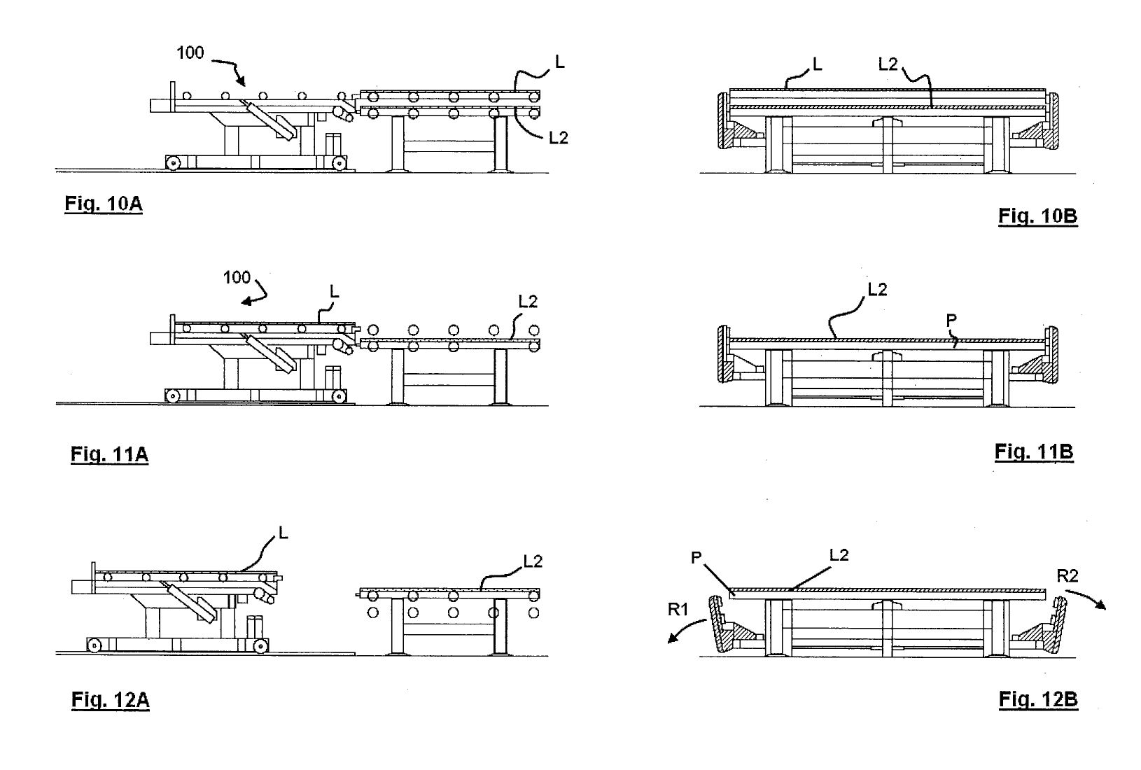

FIGS. 10A and 10B show a further step of the method, wherein the apparatus 1 takes a ninth configuration, subsequent to the preceding configuration, in which the second slab L2 to be machined is lowered by means of the first driving device to lay it on the work plane PL and the first machined slab L is simultaneously positioned at the loading/unloading plane.

During this step, the platform P with the slab L2 is preferably laid on the uprights 21, i.e. it is taken onto the work plane PL, partially lowering the frames 7.

In the subsequent step of the method, shown in FIGS. 11A and 11B, the first machined slab L is unloaded from the loading/unloading plane.

During this subsequent step of the method the height of the frames 7 remains unchanged with respect to the configuration shown in FIGS. 10A and 10B and the machined slab L is extracted from the apparatus 1, in practice pulled on the support element 103 of the truck 100 by the corresponding pushing/extracting element.

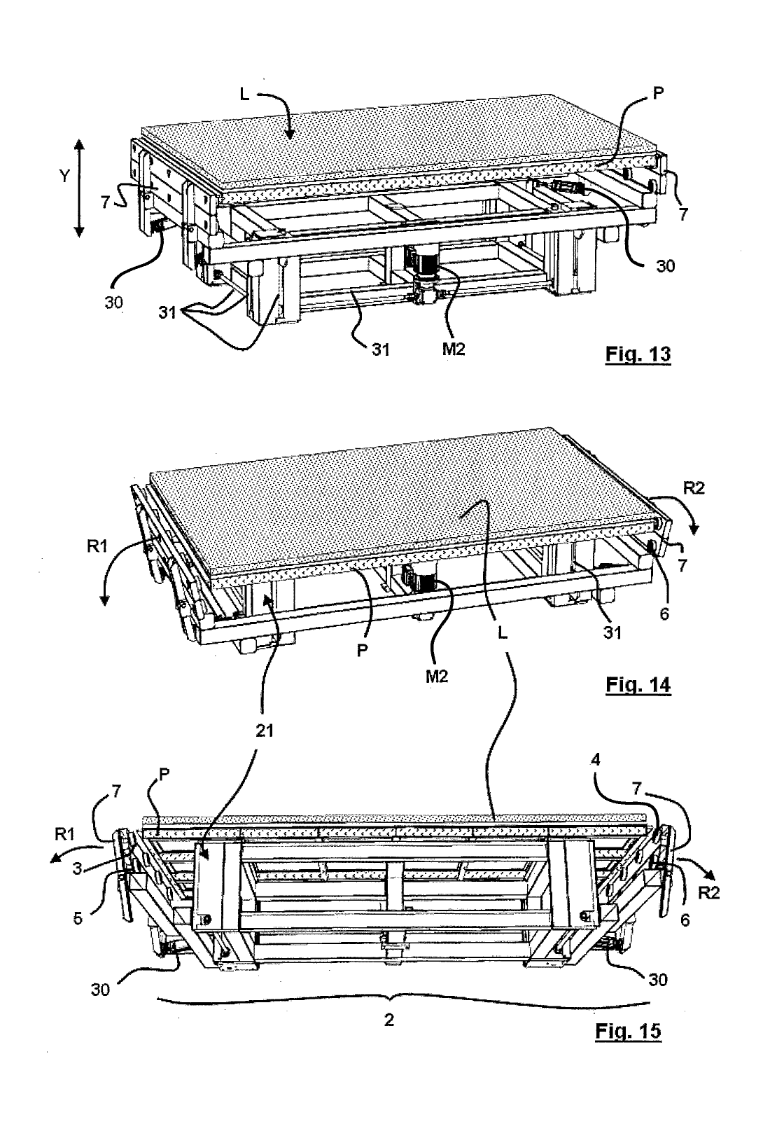

In a subsequent step of the method, shown in FIGS. 12A and 12B, the second slab L2 to be machined is preferably disengaged from the second lower support and sliding rollers 5, 6 to facilitate its machining, as described and illustrated earlier with reference to FIGS. 5A to 6B.

The apparatus 1 then takes once again an (eleventh) configuration, subsequent to the preceding one, wherein the support frames 7 of the apparatus 1 are angularly moved along the directions indicated by the arrows R1 and R2, and lowered to completely disengage the platform P and the slab L2, which remain supported on the work plane PL by the uprights 21. Now the slab L2 can be machined by the machine directly on the work plane PL in a manner analogous to that of the slab L.

Once machined, the slab L2 is unloaded as described in relation to the slab L, and a new slab L3 (not shown) is loaded on the apparatus 1. It is thus evident that the method and apparatus according to the invention allow to position the slab materials L on the work plane PL of the machine so as to minimise the waiting times of the machine itself, with outstanding advantages in terms of productivity.

In an alternative embodiment of the method of the invention, not shown in the figures, the machined slab L, L2, L3, etc. arranged on the waiting plane is picked up with known means, for example a bridge crane, so that such a waiting plane becomes the unloading plane of the slab, whereas the underlying plane arranged between the waiting plane and the work plane PL acts as a loading plane of a new slab to be machined.

In this way, it is advantageously possible to further reduce the loading, unloading and moving times, requiring however the use of additional apparatuses to pick up the slab from the waiting/unloading plane.

FIG. 13 shows in detail the apparatus 1 in the step of engaging and maximum lifting of the machined slab L at the waiting/unloading plane; FIGS. 14 and 15 show in detail the apparatus 1 in the disengaging step of the slab L to be machined when the latter is laid on the work plane PL of the machine. It is possible to see the hydraulic driving devices 30 of the second driving device that control the tilting of the support frames 7 of the rollers 3-6 with respect to the uprights 21 of the support structure 2.

In a further preferred embodiment, not shown, the frames 7 are not hinged to the support structure 2 and are horizontally displaceable to move away from the uprights 21 by means of a further embodiment of the second driving device.

In FIGS. 13 and 14 it is also partially visible the first driving device comprising, in this preferred embodiment, the screw coupling 31, which vertically moves the frames 7 and the motor M2 which drives the corresponding mechanisms in order to synchronise the movement of the frames 7.

The man skilled in the art will understand that the axial and radial extension of the rollers 3-6 can be varied based on the requirements, for example based on the weight and dimensions of the slab-carrying platforms P.

1-16. (canceled)

17. A support and handling apparatus of slab materials, comprising:
a) a support structure, defining a horizontal work plane of a slab;
b) a plurality of first supporting and sliding rollers defining a first horizontal lying plane of said slab material;
c) a plurality of second supporting and sliding rollers defining a second horizontal lying plane of said slab material beneath the first lying plane;
wherein said first and second supporting and sliding rollers are rotatably supported by respective support frames;
said apparatus further comprising:
d) a first driving device of the support frames with respect to the support structure adapted to vertically translate said support frames between:
d1) a first operative position wherein:
the second lying plane defined by the second supporting and sliding rollers is substantially coincident with a loading/unloading plane of the slab material positioned above the work plane to receive slab material to be machined;
the first lying plane defined by the first supporting and sliding rollers is substantially coincident with a waiting/unloading plane of a machined slab material positioned above the loading/unloading plane;
d2) a second operative position wherein:
the second lying plane defined by the second supporting and sliding rollers is substantially coincident with the work plane;
the first lying plane defined by the first supporting and sliding rollers is substantially coincident with said loading/unloading plane of the slab material to unload the machined slab material; and
d3) a third non-operative position wherein:
said first and second supporting and sliding rollers are positioned beneath the work plane so as not to engage slab material to be machined supported by the support structure at the work plane.

18. The apparatus according to claim 17, wherein both said first supporting and sliding rollers and said second supporting and sliding rollers are rotatably supported by said respective support frames on opposite sides with respect to the support structure.

19. The apparatus according to claim 18, wherein the movements of the opposite rollers of said first and second supporting and sliding rollers are synchronized with each other.

20. The apparatus according to claim 17, wherein said first and second supporting and sliding rollers comprise respective series of rollers opposite with respect to the support structure.

21. The apparatus according to claim 20, wherein the movements of the opposite rollers of said first and second supporting and sliding rollers are synchronized with each other.

22. The apparatus according to claim 17, wherein each frame is connected to a respective upright by means of a screw and female screw coupling of said first driving device.

23. The apparatus according to claim 17, comprising a second driving device of the support frames adapted to move said support frames with respect to the support structure along a transversal direction with respect to the vertical direction between a first position, wherein opposite rollers of said first and second supporting and sliding rollers are proximal to one another, and a second position wherein said opposite rollers of the first and second supporting and sliding rollers are distal to one another.

24. The apparatus according to claim 23, wherein each support frame is horizontally movable with respect to a respective upright of the support structure.

25. The apparatus according to claim 23, wherein each support frame is angularly movable with respect to a respective upright of the support structure in the opposite direction with respect to the other frame.

26. The apparatus according to claim 17, wherein the first driving device adapted to vertically translate each support frame with respect to the support structure comprises one or more motors.

27. The apparatus according to claim 17, wherein the waiting plane coincides with a second unloading plane of machined slab material.

28. A method for feeding a slab material to a work plane of a machine for machining the slab material by means of a support and handling apparatus of said slab material, comprising the steps of:
a) feeding a first slab material to be machined on a loading/unloading plane defined by said apparatus above a horizontal work plane of said machine, said loading/unloading plane being defined at a predetermined distance from the work plane between said work plane and a waiting plane of machined slab material;
b) lowering said first slab material by means of the apparatus to lay the first slab on the work plane for machining the slab material;
c) engaging a first machined slab material and lifting the same to the waiting plane of machined slab material, said waiting plane being defined in said apparatus above the loading/unloading plane;
d) feeding a second slab material to be machined on the loading/unloading plane defined between the work plane and the waiting plane wherein the first machined slab material is lying;
e) lowering said second slab material to be machined to lay the same on the work plane and said first machined slab material to position the same at the loading/unloading plane;
f) horizontally unloading said first machined slab material from the loading/unloading plane, and
g) repeating steps c)-f) on the second slab material and on subsequent slab materials.

29. The method according to claim 28, wherein steps a)-g) are carried out by means of the apparatus according to claim 1, and wherein:
step a) is carried out by pushing the first slab material on a second horizontal lying plane defined by the second supporting and sliding rollers;
step b) is carried out by moving the second supporting and sliding rollers downwards so that the second lying plane is substantially coincident with the work plane of the machine;
step c) is carried out by supporting the first machined slab material by means of said first supporting and sliding rollers on a first horizontal lying plane defined by said first rollers;
step d) is carried out by pushing a second slab material to be machined on the second horizontal lying plane defined by the second supporting and sliding rollers;
step e) is carried out by moving the first and the second supporting and sliding rollers so that the second horizontal lying plane is substantially coincident with the work plane of the machine and the first lying plane coincides with the loading/unloading plane; and
step f) is carried out by pushing the first machined slab material away from the loading/unloading plane.

30. The method according to claim 28, wherein the support and handling apparatus of said slab material comprises a plurality of first supporting and sliding rollers defining a first horizontal lying plane of said slab material and a plurality of second supporting and sliding rollers defining a second horizontal lying plane of said slab material, the method further comprising, between steps b) and c), a step b1) of further lowering said first and second rollers so as to position the same beneath the work plane.

31. The method according to claim 28, wherein the support and handling apparatus of said slab material comprises a plurality of first supporting and sliding rollers defining a first horizontal lying plane of said slab material and a plurality of second supporting and sliding rollers defining a second horizontal lying plane of said slab material, the method further comprising a step h), intermediate between steps b) and c), wherein said second supporting and sliding rollers are transversally moved at a distal position with respect to the work plane to disengage the first slab material to be machined and said first supporting and sliding rollers are transversally moved at a proximal position with respect to the work plane to engage the first machined slab material.

32. A method for feeding a slab material to a work plane of a machine for machining the slab material by means of a support and handling apparatus of said slab material, comprising the steps of:
a) feeding a first slab material to be machined on a loading plane defined by said apparatus above a horizontal work plane of said machine, said loading plane being defined at a predetermined distance from the work plane between the work plane and an unloading plane of machined slab material;
b) lowering said first slab material by means of the apparatus to lay the same on the work plane for machining the slab material;
c) engaging the first machined slab material and lifting the same to said unloading plane defined in said apparatus above the loading plane of the machined slab material;
d) picking up said first machined slab material from said unloading plane;
e) feeding a second slab material to be machined on the loading plane defined between the work plane and the unloading plane of the first machined slab material;
f) lowering said second slab material to be machined to lay the same on the work plane; and
g) repeating steps c)-f) on the second slab material and on subsequent slab materials.

33. The method according to claim 32, wherein steps a)-g) are carried out by means of the apparatus according to claim 1, and wherein:
step a) is carried out by pushing the first slab material on a second horizontal lying plane defined by the second supporting and sliding rollers;
step b) is carried out by moving the second supporting and sliding rollers downwards so that the second lying plane is substantially coincident with the work plane of the machine;
step c) is carried out by supporting the first machined slab material by means of said first supporting and sliding rollers on a first horizontal lying plane defined by said first rollers;
step e) is carried out by pushing a second slab material to be machined on the second horizontal lying plane defined by the second supporting and sliding rollers; and
step f) is carried out by moving the second supporting and sliding rollers downwards so that the second horizontal lying plane is substantially coincident with the work plane of the machine.

34. The method according to claim 32, wherein the support and handling apparatus of said slab material comprises a plurality of first supporting and sliding rollers defining a first horizontal lying plane of said slab material and a plurality of second supporting and sliding rollers defining a second horizontal lying plane of said slab material, the method further comprising, between steps b) and c), a step b1) of further lowering said first and second rollers so as to position the same beneath the work plane.

35. The method according to claim 32, wherein the support and handling apparatus of said slab material comprises a plurality of first supporting and sliding rollers defining a first horizontal lying plane of said slab material and a plurality of second supporting and sliding rollers defining a second horizontal lying plane of said slab material, the method further comprising a step h), intermediate between steps b) and c), wherein said second supporting and sliding rollers are transversally moved at a distal position with respect to the work plane to disengage the first slab material to be machined and said first supporting and sliding rollers are transversally moved at a proximal position with respect to the work plane to engage the first machined slab material.
